(19) United States
(12) Patent Application Publication
(10) Pub. No.: US 2007/0185300 A1
(43) Pub. Date: Aug. 9, 2007

(54) Photocurable resin composition for optical waveguide formation, photocurable dry film for optical waveguide formation, and optical waveguide

(75) Inventors: Daisuke Kojima, Kanagawa (JP); Takahiro Higuchi, Kanagawa (JP); Genji Imai, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Kansai Paint Co., Ltd., Amagasaki-shi (JP)

(21) Appl. No.: 10/588,717

(22) PCT Filed: Feb. 25, 2005
(86) PCT No.: PCT/JP05/03209

§ 371 Date: Aug. 8, 2006

(30) Foreign Application Priority Data
Feb. 25, 2004 (JP) 2004-049826

(51) Int. Cl. C08G 18/00

(52) U.S. Cl. 528/44

(57) ABSTRACT

The present invention provides a photocurable resin composition for forming an optical waveguide, the composition comprising (A) a carboxy-containing unsaturated polyurethane resin obtained by reacting a polyisocyanate compound (a), a carboxy-containing polyol (b) and a hydroxy-containing unsaturated compound (c), and (B) a solvent; a photocurable dry film for forming an optical waveguide; and an optical waveguide.

### TECHNICAL FIELD

The present invention relates to a photocurable resin composition for forming an optical waveguide, a curable dry film for forming an optical waveguide, and an optical waveguide formed using the composition or dry film.

### BACKGROUND ART

In recent years, optical waveguides have been attracting attention as optical transmission media that meet the demand for increased capacity and speed of information processing in optical communication systems, computers, etc.

Quartz waveguides are representative optical waveguides, but have problems in that they require special production facilities, long production times, etc.

As substitutes for such quartz waveguides, organic polymer optical waveguides which are free from the above problems have been developed.

Japanese Unexamined Patent Publication No. 2003-149475 discloses a resin composition for forming an optical waveguide, the composition comprising an ethylenically unsaturated group-containing carboxylic acid resin having at least one ethylenically unsaturated group and at least one carboxy group per molecule; a diluent; and a photopolymerization initiator.

However, the composition has a problem in that the production process for the ethylenically unsaturated group-containing carboxylic acid resin is complicated. Specifically, the resin is produced by a complicated process in which an epoxy resin having at least two epoxy groups per molecule is reacted with (meth)acrylic acid, optionally together with a compound having one carboxy group and two hydroxy groups per molecule, and then the reaction product is further reacted with a polybasic acid anhydride. Further, in some cases, unsaturated groups and carboxy groups are not sufficiently introduced into the resin.

Furthermore, the above optical waveguide-forming resin composition has a drawback in that films formed using the composition have poor processability, poor mechanical properties, etc. Therefore, it is difficult to use the composition as a dry film.

### DISCLOSURE OF THE INVENTION

### Problems to be Solved by the Invention

An object of the present invention is to provide a photocurable resin composition and photocurable dry film that can form coating films having excellent processability, excellent mechanical properties, etc., and that are very useful for forming optical waveguides; and an optical waveguide obtained using the resin composition and/or the dry film.

### MEANS FOR SOLVING THE PROBLEMS

The present inventors conducted extensive research to achieve the above object, and as a result, found that the above object can be achieved by a resin composition comprising a specific carboxy-containing unsaturated polyurethane resin and a solvent. The present invention was accomplished based on this new finding.

The present invention provides the following optical waveguide-forming photocurable resin composition, optical waveguide-forming photocurable dry film, and optical waveguide.

1. A photocurable resin composition for forming an optical waveguide, the composition comprising:

(A) a carboxy-containing unsaturated polyurethane resin obtained by reacting a polyisocyanate compound (a), a carboxy-containing polyol (b) and a hydroxy-containing unsaturated compound (c); and

(B) a solvent.

2. The photocurable resin composition according to item 1, wherein the polyisocyanate compound (a) is an aromatic diisocyanate.

3. The photocurable resin composition according to item 1, wherein the hydroxy-containing unsaturated compound (c) is an unsaturated compound (c-1) having one hydroxy group and one unsaturated group per molecule.

4. The photocurable resin composition according to item 1, wherein the hydroxy-containing unsaturated compound (c) is an unsaturated compound (c-2) having one hydroxy group and at least two unsaturated groups per molecule.

5. The photocurable resin composition according to item 1, wherein the hydroxy-containing unsaturated compound (c) is an unsaturated compound (c-3) having at least two hydroxy groups and one unsaturated group per molecule.

6. The photocurable resin composition according to item 1, wherein the hydroxy-containing unsaturated compound (c) is an unsaturated compound (c-4) having at least two hydroxy groups and at least two unsaturated groups per molecule.

7. The photocurable resin composition according to item 1, wherein the carboxy-containing unsaturated polyurethane resin (A) is a resin obtained by reacting a polyisocyanate compound (a), a carboxy-containing polyol (b), a hydroxy-containing unsaturated compound (c), and a polyol (d) other than the polyol (b).

8. The photocurable resin composition according to item 7, wherein the polyol (d) is an aromatic polyol.

9. The photocurable resin composition according to item 1, further comprising a radical photopolymerization initiator.

10. A photocurable dry film for forming an optical waveguide, which is formed using the photocurable resin composition according to item 1.

11. The photocurable dry film according to item 10, which has a softening temperature within a range of 0° C. to 300° C.

12. An optical waveguide comprising a lower cladding layer (I), a core (II) and an upper cladding layer (III), wherein at least one of (I), (II) and (III) is formed using the photocurable resin composition according to item 1.

13. An optical waveguide comprising a lower cladding layer (I), a core (II) and an upper cladding layer (III), wherein at least one of (I), (II) and (III) is formed using the photocurable dry film according to item 10.

Photocurable Resin Composition for Forming Optical Waveguide

The optical waveguide-forming photocurable resin composition of the present invention comprises a carboxy-containing unsaturated polyurethane resin (A) obtained by reacting a polyisocyanate compound (a), a carboxy-containing polyol (b), a hydroxy-containing unsaturated compound (c), and optionally a polyol (d); and a solvent (B).

Polyisocyanate Compound (a)

The polyisocyanate compound (a) is used to bond the carboxy-containing polyol (b), which introduces carboxy groups into the resin (A), to the hydroxy-containing unsaturated compound (c), which introduces photopolymerizable unsaturated groups into the resin (A).

Polyisocyanate compounds include, for example, aliphatic diisocyanates, aromatic diisocyanates, alicyclic diisocyanates and other polyisocyanates.

Examples of aliphatic diisocyanates include hexamethylene diisocyanate, trimethylene diisocyanate, 1,4-tetramethylene diisocyanate, pentamethylene diisocyanate, 1,2-propylene diisocyanate, 1,2-butylene diisocyanate, trimethylhexamethylene diisocyanate, dimer acid diisocyanate, lysine diisocyanate, 2,3-butylene diisocyanate, 1,3-butylene diisocyanate, etc.

Examples of alicyclic diisocyanates include isophorone diisocyanate, 4,4′-methylenebis(cyclohexyl isocyanate), methylcyclohexane-2,4-diisocyanate, methylcyclohexane-2,6-diisocyanate, 1,3-di(isocyanatomethyl)cyclohexane, 1,4-di(isocyanatomethyl)cyclohexane, 1,4-cyclohexane diisocyanate, 1,3-cyclopentane diisocyanate, 1,2-cyclohexane diisocyanate, etc.

Examples of aromatic diisocyanates include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenylether diisocyanate, m-phenylene diisocyanate, p-phenylene diisocyanate, 4,4′-biphenylene diisocyanate, 3,3′-dimethyl-4,4′-biphenylene diisocyanate, bis(4-isocyanatophenyl)sulfone, isopropylidenebis(4-phenylisocyanate), etc.

Examples of other polyisocyanates include triphenylmethane-4,4′,4″-triisocyanate, 1,3,5-triisocyanatobenzene, 2,4,6-triisocyanatotoluene, 4,4′-dimethyldiphenylmethane-2,2′,5,5′-tetraisocyanate and like polyisocyanates having at least three isocyanate groups; adducts obtained by reacting a polyisocyanate with a polyol such as ethylene glycol, propylene glycol, 1,4-butylene glycol, polyalkylene glycol, trimethylolpropane, hexane triol or the like, in such a ratio that the isocyanate groups are present in excess relative to the hydroxy groups of the polyol; biuret-type adducts or isocyanuric ring-type adducts of polyisocyanates such as hexamethylene diisocyanate, isophorone diisocyanate, tolylene diisocyanate, xylylene diisocyanate, 4,4′-diphenylmethane diisocyanate, 4,4′-methylenebis(cyclohexyl isocyanate), etc.; and the like.

Such polyisocyanate compounds can be used singly or in combination.

Among the compounds mentioned above, aromatic diisocyanates are especially preferable, since they hardly undergo alkaline hydrolysis and thus are capable of forming photocurable layers with high resistance to alkaline developers, and since they are capable of forming optical waveguides made of tough coating films. Aromatic diisocyanates are especially preferable also because they can form cores with high refractive indices.

Carboxy-Containing Polyol (b)

The carboxy-containing polyol (b) introduces carboxy groups into the resin (A) to make it possible to remove, with an alkaline developer, the unirradiated portion of a coating film containing the resin. The polyol (b) also imparts water dispersibility to the resin.

Compounds usable as the carboxy-containing polyol (b) include those having at least one carboxy group and at least two hydroxy groups per molecule. Specific examples include 2,2-dimethylolpropionic acid, 2,2-dimethylolacetic acid, 2,2-dimethylolpentanoic acid, half ester compounds obtained by reacting triol compounds with acid anhydride compounds, sulfonate diol compounds obtained by transesterification of sodium dimethyl sulfoisophthalate with an excess of glycol, etc.

Such compounds can be used singly or in combination.

Hydroxy-Containing Unsaturated Compound (c)

A compound containing unsaturated group(s) that, when irradiated with light, undergoes a radical polymerization reaction and thereby forms a crosslinked structure is used as the hydroxy-containing unsaturated compound (c). Such unsaturated groups may be known unsaturated groups, and preferable examples include (meth)acryloyl groups.

The hydroxy-containing unsaturated compound (c) may be, for example, an unsaturated compound (c-1) having one hydroxy group and one unsaturated group per molecule; an unsaturated compound (c-2) having one hydroxy group and at least two unsaturated groups per molecule; an unsaturated compound (c-3) having at least two hydroxy groups and one unsaturated group per molecule; an unsaturated compound (c-4) having at least two hydroxy groups and at least two unsaturated groups per molecule; or the like. Such compounds can be used singly or in combination.

Examples of the unsaturated compound (c-1) having one hydroxy group and one unsaturated group per molecule include 2-hydroxyethyl (meth)acrylate, 3-hydroxypropyl (meth)acrylate, etc.

Examples of the unsaturated compound (c-2) having one hydroxy group and at least two unsaturated groups per molecule include glycerol di(meth)acrylate, diglycerol tri(meth)acrylate, trimethylolpropane di(meth)acrylate, pentaerythritol tri(meth)acrylate, dipentaerythritol penta(meth)acrylate, etc.

Examples of the unsaturated compound (c-3) having at least two hydroxy groups and one unsaturated group per molecule include glycerol mono(meth)acrylate, diglycerol mono(meth)acrylate, pentaerythritol mono(meth)acrylate, dipentaerythritol mono(meth)acrylate, dipentaerythritol mono(meth)acrylate, dipentaerythritol mono(meth)acrylate, sorbitol mono(meth)acrylate, etc.

Examples of the unsaturated compound (c-4) having at least two hydroxy groups and at least two unsaturated groups per molecule include diglycerol di(meth)acrylate, pentaerythritol di(meth)acrylate, dipentaerythritol di(meth)acrylate, dipentaerythritol tri(meth)acrylate, dipentaerythritol tetra(meth)acrylate, sorbitol di(meth)acrylate, sorbitol tri(meth)acrylate, sorbitol tetra(meth)acrylate, sorbitol penta(meth)acrylate, (meth)acrylic acid adducts of diglycidyl ether compounds, etc. Examples of (meth)acrylic acid adducts of diglycidyl ether compounds include (meth)acrylic acid adducts of bisphenol A glycidyl ether.

Polyol (d)

The polyol (d) is a polyol other than the carboxy-containing polyol (b). The polyol (d) is a compound having at least two hydroxy groups per molecule, and encompasses, for example, aliphatic polyols, aromatic polyols, alicyclic polyols and other polyols. Such compounds can be used singly or in combination.

Examples of aliphatic polyols include (poly)methylene glycol, (poly)ethylene glycol, (poly)propylene glycol, 1,4-butanediol, 1,3-butanediol, 2,3-butanediol, 1,2-butanediol, 3-methyl-1,2-butanediol, 1,2-pentanediol, 1,5-pentanediol, 1,4-pentanediol, 2,4-pentanediol, 2,3-dimethyltrimethylene glycol, 3-methyl-4,3-pentanediol, 3-methyl-4,5-pentanediol, 2,2,4-trimethyl-1,3-pentanediol, 1,6-hexanediol, 1,5-hexanediol, 1,4-hexanediol, 2,5-hexanediol, 1,4-cyclohexanedimethanol, neopentyl glycol, pentaerythritol, trimethylolpropane, glycerol, etc.

Examples of alicyclic polyols include 1,4-cyclohexanedimethanol, tricyclodecanedimethanol, hydrogenated bisphenol A, hydrogenated bisphenol F, hydrogenated bisphenol B, alkylene oxide adducts of hydrogenated bisphenol A, alkylene oxide adducts of hydrogenated bisphenol B, alkylene oxide adducts of hydrogenated bisphenol F, etc.

Examples of aromatic polyols include bisphenol A, bisphenol F, bisphenol B, alkylene oxide adducts of bisphenol A, alkylene oxide adducts of bisphenol B, alkylene oxide adducts of bisphenol F, etc.

Examples of alkylene oxides include methylene oxide, ethylene oxide, propylene oxide, butylene oxide, etc.

Examples of other polyols include polycarbonate diol, polyester diol, polycaprolactone diol, vinyl ether oligomers having OH groups on both ends, etc.

Among the above polyols, aromatic polyols are preferable since use thereof makes it possible to form cores with high refractive indices.

The carboxy-containing unsaturated polyurethane resin (A) for use in the composition of the present invention can be produced by known methods for producing conventional polyurethane resins.

That is, the carboxy-containing polyol (b) and polyisocyanate compound (a) are first mixed so that isocyanate groups are present in excess, and an addition reaction of isocyanate groups with hydroxy groups is performed to produce a carboxy-containing isocyanate compound. In this reaction, the molar ratio of isocyanate groups to hydroxy groups is usually about 2.0:1 to about 1.1:1, and preferably about 2.0:1 to about 1.2:1. Subsequently, the hydroxy-containing unsaturated compound (c) is added to the carboxy-containing isocyanate compound so that the molar ratio of isocyanate groups to hydroxy groups becomes about 0.8:1 to about 1.0:1, and preferably about 0.9:1 to about 1.0:1, and an addition reaction was performed to obtain a carboxy-containing unsaturated polyurethane resin (A). Before the reaction with the hydroxy-containing unsaturated compound (c), carboxy groups of the carboxy-containing isocyanate compound may be blocked by esterification with a lower alcohol, and, after the reaction, carboxy groups can be recovered by removing the lower alcohol by heating. Examples of lower alcohols include methanol, ethanol, propanol, etc.

When using the polyol (d), the polyol (d), carboxy-containing polyol (b) and polyisocyanate compound (a) are first mixed so that isocyanate groups are present in excess, and an addition reaction of isocyanate groups with hydroxy groups is performed to produce a carboxy-containing isocyanate compound. In this reaction, the molar ratio of isocyanate groups to hydroxy groups is usually about 2.0:1 to about 1.1:1, and preferably about 2.0:1 to about 1.2:1. Subsequently, the hydroxy-containing unsaturated compound (c) is added to the carboxy-containing isocyanate compound so that the molar ratio of isocyanate groups to hydroxy groups becomes about 0.8:1 to about 1.0:1, and preferably about 0.9:1 to about 1.0:1, and an addition reaction is performed to obtain a carboxy-containing unsaturated polyurethane resin (A). Before the reaction with the hydroxy-containing unsaturated compound (c), carboxy groups of the carboxy-containing isocyanate compound may be blocked by esterification with a lower alcohol, and, after the reaction, carboxy groups can be recovered by removing the lower alcohol by heating. Examples of lower alcohols include methanol, ethanol, propanol, etc.

Alternatively, the carboxy-containing polyol (b), hydroxy-containing unsaturated compound (c) and optionally polyol (d) may be first mixed, followed by a reaction with the polyisocyanate compound (a), to obtain the carboxy-containing unsaturated polyurethane resin (A).

In the addition reaction of isocyanate groups with hydroxy groups, the temperature of the reaction system is usually 50 to 150° C., but is preferably not higher than 100° C. to prevent polymerization of radically polymerizable unsaturated groups. The addition reaction can be promoted by using a urethanization catalyst. Examples of preferable urethanization catalysts include tin octylate, dibutyltin dilaurate and like organotin compounds.

In the production of the carboxy-containing unsaturated polyurethane resin (A), organic solvents can be used as required. Examples of usable organic solvents include acetone, methyl ethyl ketone, methyl isobutyl ketone, ethyl acetate, butyl acetate, toluene, xylene, N,N-dimethylformamide, N-methyl-2-pyrrolidone, etc.

The optical waveguide-forming photocurable resin composition of the present invention contains the carboxy-containing unsaturated polyurethane resin (A), and when the composition is irradiated with light, it is cured by polymerization and crosslinking of unsaturated groups in the resin. Examples of light that can be used for irradiation include electron rays, ultraviolet rays, visible rays and like active energy rays. When irradiation with ultraviolet rays or visible rays is performed to effect crosslinking, radical photopolymerization initiators and optionally photosensitizers (photosensitizing dyes) can be added.

Known radical photopolymerization initiators can be used, including, for example, benzophenone, benzoin methyl ether, benzoin isopropyl ether, benzylxanthone, thioxanthone, anthraquinone and like aromatic carbonyl compounds; acetophenone, propiophenone, α-hydroxyisobutylphenone, α,α′-dichloro-4-phenoxyacetophenone, 1-hydroxy-1-cyclohexylacetophenone, diacetylacetophenone, acetophenone and like acetophenone compounds; benzoyl peroxide, t-butylperoxy-2-ethylhexanoate, t-butylhydroperoxide, di-t-butyldiperoxyisophthalate, 3,3′,4,4′-tetra(t-butylperoxycarbonyl)benzophenone and like organic peroxides; diphenyliodonium bromide, diphenyliodonium chloride and like diphenylhalonium salts; carbon tetrabromide, chloroform, iodoform and like organic halides; 3-phenyl-5-isoxazolone, 2,4,6-tris(trichloromethyl)-1,3,5-triazine benzanthrone and like heterocyclic and polycyclic compounds; 2,2′-azo(2,4-dimethylvaleronitrile), 2,2-azobisisobutyronitril, 1,1′-azobis(cyclohexane-1-carbonitrile), 2,2′-azobis(2-methylbutyronitrile) and like azo compounds; iron-allene complexes; titanocene compounds; bisimidazole compounds; N-aryl glycidyl compounds; acridine compounds; combinations of aromatic ketones and aromatic amines; peroxyketals, etc. Usable iron-allene complexes, titanocene compounds and peroxyketals are disclosed in European Patent No. 152377, Japanese Unexamined patent Publication No. 1988-221110 and Japanese Unexamined Patent Publication No. 1994-321895, respectively.

Such radical photopolymerization initiators can be used singly or in combination.

Among these radical photopolymerization initiators, di-t-butyldiperoxyisophthalate, 3,3′,4,4′-tetra(t-butylperoxycarbonyl)benzophenone, iron-allene complexes and titanocene compounds are preferable, since they have high activity for crosslinking or polymerization.

Commercial radical photopolymerization initiators are usable, including, for example, “Irgacure 651” (tradename of Ciba Speciality Chemicals; acetophenone radical photopolymerization initiator), “Irgacure 184” (tradename of Ciba Speciality Chemicals; acetophenone radical photopolymerization initiator), “Irgacure 1850” (tradename of Ciba Speciality Chemicals; acetophenone radical photopolymerization initiator), “Irgacure 907” (tradename of Ciba Speciality Chemicals; aminoalkylphenone radical photopolymerization initiator), “Irgacure 369” (tradename of Ciba Speciality Chemicals; aminoalkylphenone radical photopolymerization initiator), “Lucirin TPO” (tradename of BASF A.G.; 2,4,6-trimethylbenzoyldiphenylphosphine oxide), “Kayacure DETXS” (tradename of Nippon Kayaku Co., Ltd.), “CGI-784” (tradename of Ciba Speciality Chemicals; titanium complex compound), etc.

When a radical photopolymerization initiator is used in the photocurable resin composition of the present invention, the proportion thereof is preferably about 0.5 to about 10 parts by weight per 100 parts by weight of carboxy-containing unsaturated polyurethane resin (A).

Examples of photosensitizing dyes include thioxanthene dyes, xanthene dyes, ketone dyes, thiopyrylium salt dyes, bisstyryl dyes, merocyanine dyes, 3-substituted coumarin dyes, 3,4-substituted coumarin dyes, cyanine dyes, acridine dyes, thiazine dyes, phenothiazine dyes, anthracene dyes, coronene dyes, benzanthracene dyes, perylene dyes, merocyanine dyes, ketocoumarin dyes, fumarine dyes, borate dyes, etc. Such dyes can be used singly or in combination. Examples of borate photosensitizing dyes include those mentioned in Japanese Unexamined Patent Publications No. 1993-241338, No. 1995-5685 and No. 1995-225474.

The photocurable resin composition of the present invention may contain, where necessary, a polyepoxide.

Examples of usable polyepoxides include bisphenol-type epoxy resins obtained by reacting bisphenols with haloepoxides such as epichlorohydrin, β-methylepichlorohydrin, etc.; halogenated bisphenol-type epoxy resins; phosphorus-modified bisphenol-type epoxy resins obtained by reaction with phosphorus compounds; alicyclic epoxy resins obtained by hydrogenating bisphenol-type epoxy resins; novolac-type epoxy resins obtained by reacting haloepoxides with phenol novolac resins, cresol novolac resins, etc.; glycidyl ester-type epoxy resins obtained by reacting epichlorohydrin with polybasic acids such as phthalic acid, dimer acid, etc.; glycidyl amine-type epoxy resins obtained by reacting epichlorohydrin with polyamines such as diaminodiphenylmethane, isocyanuric acid, etc.; linear aliphatic epoxy resins and alicyclic epoxy resins obtained by oxidizing olefin bonds in polyolefins with peracids such as peracetic acid; biphenyl-type epoxy resins obtained by reacting biphenols with epichlorohydrin; etc.

Among such polyepoxides, bisphenol-type epoxy resins, novolac-type epoxy resins, modified resins of these, etc., can be preferably used since they are highly effective for improving heat resistance, which is required of optical waveguides.

The photocurable resin composition of the present invention may contain, if necessary, ethylenically unsaturated compounds; adhesion promoters; hydroquinone, 2,6-di-t-butyl-p-cresol, N,N-diphenyl-p-phenylenediamine and like polymerization inhibitors; saturated resins; unsaturated resins; fine particles of organic resins such as vinyl polymers, unsaturated group-containing vinyl polymers, etc.; coloring pigments, extender pigments and like pigments; cobalt oxide and like metal oxides; dibutyl phthalate, dioctyl phthalate, tricresyl phosphate, polyethylene glycol, polypropylene glycol and like plasticizers; anticissing agents; fluidity controlling agents; etc.

Examples of ethylenically unsaturated compounds include polymerizable monomers that have at least one, and preferably 1 to 4, radically polymerizable ethylene groups and that, when exposed to light, undergo addition polymerization to render the exposed portion insoluble; and oligomers of such monomers. Examples of such compounds include acrylic acid, methacrylic acid, ethylene glycol di(meth)acrylate, diethylene glycol di(meth)acrylate, triethylene glycol di(meth)acrylate, poly(tetra to hexadeca)ethylene glycol di(meth)acrylate, propylene glycol di(meth)acrylate, trimethylolpropane tri(meth)acrylate, pentaerythritol tetra(meth)acrylate, ethylene glycol diitaconate, ethylene glycol dimaleate, hydroquinone di(meth)acrylate, resorcinol di(meth)acrylate, pyrogallol (meth)acrylate, oligourethane acrylate, oligoepoxy acrylate, divinylbenzene, etc. Such ethylenically unsaturated compounds can be used singly or in combination.

The amount of ethylenically unsaturated compound to be used is preferably not more than about 200 parts by weight, and more preferably about 3 to about 50 parts by weight, per 100 parts by weight of carboxy-containing unsaturated polyurethane resin (A).

Saturated resins can be used to suppress the solubility of films of the photocurable resin composition in, for example, alkaline developers or the like. Examples of saturated resins include polyester resins, alkyd resins, (meth)acrylic resins, vinyl resins, epoxy resins, phenol resins, natural resins, synthetic rubbers, silicon resins, fluororesins, polyurethane resins, etc. Such resins can be used singly or in combination.

Examples of unsaturated resins include the same resins as mentioned above as saturated resins except that unsaturated resins have an average of about 1 to about 10, and more preferably an average of about 1 to about 4, unsaturated groups per molecule.

The amount of saturated resin and/or unsaturated resin to be used is preferably not more than about 200 parts by weight, and more preferably about 3 to about 50 parts by weight, per 100 parts by weight of carboxy-containing unsaturated polyurethane resin (A).

The photocurable resin composition of the present invention may further contain, for example, fillers, coloring agents, leveling agents, heat-resistant stabilizers, discoloration preventing agents, antioxidants, mold releasing agents, surface treating agents, flame retardants, viscosity modifiers, plasticizers, antimicrobial agents, mildew-proofing agents, antifoaming agents, coupling agents, etc., as required.

The optical waveguide-forming photocurable resin composition of the present invention is an organic solvent-based liquid resin composition or aqueous liquid resin composition comprising the carboxy-containing unsaturated polyurethane resin (A) and solvent (B) as essential components.

The solvent (B) may be an organic solvent and/or water. The solvent used in the production of the resin (A) can be used as such, as the solvent (B). Additional solvents can be used if necessary. Examples of organic solvents include ketones, esters, ethers, cellosolves, aromatic hydrocarbons, alcohols, halogenated hydrocarbons, etc.

The amount of solvent (B) is preferably about 30 to about 2,000 parts by weight per 100 parts by weight of carboxy-containing unsaturated polyurethane resin (A).

The organic solvent-based liquid resin composition can be prepared by dissolving or dispersing the carboxy-containing unsaturated polyurethane resin (A) and optional components in an organic solvent as the solvent (B). Usable organic solvents include those mentioned above.

The aqueous liquid resin composition can be prepared by dissolving or dispersing the carboxy-containing unsaturated polyurethane resin (A) and optional components in water or a mixture of water and an organic solvent. The carboxy-containing unsaturated polyurethane resin (A) is made soluble or dispersible in water by neutralizing carboxy groups in the resin (A) with an alkaline neutralizer.

Examples of alkaline neutralizers include monoethanolamine, diethanolamine, triethylamine, diethylamine, dimethylaminoethanol, cyclohexylamine, ammonia, etc. The amount of neutralizer to be used is preferably 0.2 to 1.0 equivalent, and more preferably 0.3 to 0.8 equivalents, per equivalent of carboxy groups.

The organic solvent-based or aqueous liquid resin composition, which is a photocurable resin composition of the present invention, can be applied on an optical waveguide substrate by roller coating, roll coating, spin coating, knife edge coating, curtain roll coating, spray coating, electrostatic coating, dip coating, silk printing or like method, and dried to obtain a coating film for an optical waveguide.

Examples of optical waveguide substrates include silicon substrates, quartz substrates, polyimide substrates, PET substrates, liquid crystal polymer substrates, copper foil, copper clad laminates, substrates with circuits formed thereon, etc.

The optical waveguide-forming photocurable dry film of the present invention is formed using the photocurable resin composition of the present invention. The dry film is preferable from the viewpoint of environmental protection, safety, workability, etc.

The photocurable dry film of the present invention can be obtained by, for example, applying the organic solvent-based or aqueous liquid resin composition of the present invention on a base film by roller coating, roll coating, spin coating, knife edge coating, curtain roll coating, spray coating, electrostatic coating, dip coating, silk printing or like method, followed by drying. The dry film preferably has a thickness of about 1 μm to about 2 mm, and more preferably about 1 μm to about 1 mm. The dry film may be provided with a cover coat layer, where necessary. The cover coat layer can be formed on the dry film by coating or bonding.

Usable base films for producing the dry film include, for example, films of polyethylene terephthalate, aramid, Kapton, polymethylpentene, polyethylene, polypropylene, etc., among which polyethylene terephthalate films are preferable to achieve low cost and good properties of the dry film. The base film preferably has a thickness of about 1 μm to about 10 mm, and more preferably about 10 μm to about 1 mm.

The dry film thus obtained can be bonded to a substrate to form a cladding layer, core or the like of an optical waveguide. Two or more dry films can be bonded in layers. The base film may be but need not be peeled off before bonding the dry film. To form a core, the bonded dry film can be cured by exposure to light such as ultraviolet rays, visible rays or the like so as to form a core pattern, and after peeling the base film when it has not been peeled off, the cured film can be developed to obtain a patterned core.

The dry film formed using the photocurable resin composition of the present invention preferably has a softening temperature within the range of about 0° C. to about 300° C., and more preferably within the range of about 10° C. to about 250° C. When the dry film has a softening temperature lower than the above, the dry film is softened and becomes sticky when heated for bonding to a substrate, making bonding operation extremely difficult and/or forming bubbles after bonding. When the dry film has a softening temperature higher than the above, bonding of the dry film is difficult.

As used herein, the softening temperature is determined from thermal deformation behavior of a 1 mm-thick resin sheet, using a thermomechanical analyzer. Specifically, a load of 49 g is applied to a quartz needle placed on the sheet; the sheet is heated at a rate of 5° C./min; and the temperature at which the needle penetrates into the sheet to a depth of 0.635 mm is defined as the softening temperature. Examples of usable thermomechanical analyzers include those commercially available from Du Pont.

Light sources usable for photocuring include, for example, extra-high-pressure mercury lamps, high-pressure mercury lamps, medium-pressure mercury lamps, low-pressure mercury lamps, chemical lamps, carbon arc lamps, xenon lamps, metal halide lamps, tungsten lamps, etc. Various lasers having oscillation lines in the ultraviolet or visible region can also be used. Examples of preferable lasers include argon lasers having oscillation lines at 355 nm, YAG-THG lasers having oscillation lines at 355 nm, semiconductor (InGaN) lasers having oscillation lines at 405 nm, argon lasers having oscillation lines at 488 nm, YAG-SHG lasers having oscillation lines at 532 nm, etc.

Optical Waveguide

The optical waveguide of the present invention comprises a lower cladding layer (I), a core (II) and an upper cladding layer (III), and at least one of (I), (II) and (III) is formed using the optical waveguide-forming photocurable resin composition or dry film of the present invention.

In the optical waveguide of the present invention, all of the lower cladding layer (I), core (II) and upper cladding layer (III) may be formed using the photocurable resin composition of the present invention, or all of (I), (II) and (III) may be formed using the photocurable dry film of the present invention. The optical waveguide of the present invention may also be formed by combined use of the resin composition and dry film of the present invention. If necessary, it is also possible to form (I), (II) and (III) partially using known optical waveguide-forming composition(s) and/or dry film(s). It is especially preferable to form the core (II) using the resin composition or dry film of the present invention.

In the optical waveguide of the present invention, it is preferable that the relative refractive index difference between the core (II) and whichever of the lower cladding layer (I) and upper cladding layer (III) that has the higher refractive index, be at least 0.1%.

As used herein, the relative refractive index difference is defined by the following equation (1).
Relative refractive index difference (%)=[(n₁−n₂)/n₂]×100 (1)
wherein n₁ is the refractive index of the core (II); n₂ is the refractive index of whichever of the lower cladding layer (I) and upper cladding layer (III) that has the higher reflective index. These refractive indices are measured using an Abbe refractometer with light having a wavelength of 850 nm.

In order to obtain the above relative refractive index difference, the refractive index of the core (II) needs to be higher than the refractive indices of both the lower cladding layer (I) and upper cladding layer (III).

In the optical waveguide of the present invention, it is usually preferable that, for light having a wavelength of 400 to 1,700 nm, the core (II) have a refractive index of 1.420 to 1.650, and that each of the lower cladding layer (I) and upper cladding layer (III) has a refractive index of 1.400 to 1.648. The refractive indices can be adjusted by suitably selecting the resins, additives, proportions thereof, etc.

In the optical waveguide of the present invention, the thicknesses of the lower cladding layer (I), upper cladding layer (III) and core (II) are not limited, and are preferably each about 1 to about 200 μm. The core (II) usually has a square cross section. The width of the core (II) is not limited, and is preferably about 1 to about 200 μm.

Process for Producing Optical Waveguide

The optical waveguide of the present invention can be produced by forming, on a substrate, the lower cladding layer (I), core (II) and upper cladding layer (III) in this order.

The optical waveguide of the present invention can be produced by a process known per se, except for using the photocurable resin composition or dry film of the present invention for forming at least one of the lower cladding layer (I), core (II) and upper cladding layer (III). The process for producing the optical waveguide is described below.

Lower Cladding Layer (I)

The lower cladding layer (I) can be formed using the optical waveguide-forming photocurable resin composition or dry film of the present invention. It is also possible to form the lower cladding layer (I) using a known composition or dry film containing, for example, a thermoplastic resin, curable resin or like resin.

Known resin compositions and dry films are described below.

Examples of thermoplastic resins include acrylic resins, epoxy resins, silicon resins, polycarbonate resins, siloxane resins, polyimide resins, polyurethane resins, oxetane resins, polyethersulfone resins, polyphenyl sulfide resins, polyether imide resins, polysulfone resins, polyether ketone resins, polyamide resins, polyethylene resins, polypropylene resins, polyethylene terephthalate resins, phenol novolac resins, ethylene-vinyl alcohol copolymers, ethylene-vinyl acetate copolymers, polystyrene resins, fluororesins, polybutylene terephthalate resins, polyacetals resins, polyether nitrile resins, polyamide resins, Polyamide 11, polyolefin-maleimide copolymers, aramid resins, liquid crystal polymers, polyether ketone resins, cyanate resins, etc. Examples of liquid crystal polymers include polyacetals copolymer and the like.

Examples of curable resins include thermosetting resins, room temperature-curable resins, active energy ray-curable resins, etc.

Known thermosetting resins are usable, including, for example, combinations of base resins having heat-reactive functional groups, and curing agents having functional groups that are reactive with the heat-reactive functional groups. Also usable are self-crosslinking resins having N-methylol groups, N-alkoxymethylol groups, etc.

Examples of combinations of heat-reactive functional groups and functional groups reactive therewith include carboxy groups and epoxy groups (oxirane groups); carboxylic anhydrides and epoxy groups (oxirane groups); amino groups and epoxy groups (oxirane groups); carboxy groups and hydroxy groups; carboxylic anhydrides and hydroxy groups; blocked isocyanate groups and hydroxy groups; isocyanate groups and amino groups; etc.

Examples of room temperature-curable resins include oxidation-curable unsaturated resins, isocyanate-curable resins, etc.

Preferable active energy ray-curable resins include resins containing, as essential components, compounds each having at least two ring-opening polymerizable functional groups per molecule, optionally in combination with active energy ray polymerization initiators; polymerizable unsaturated compounds, unsaturated resins, etc., optionally in combination with active energy ray polymerization initiators; and the like. Also usable are active energy ray-curable resins for use in the negative-type active energy ray-sensitive resin compositions described hereinafter. Active energy ray-curable resin compositions can be cured by irradiating the entire surfaces of films formed therefrom.

Such a thermoplastic resin or curable resin, optionally together with a curing agent or the like, is dissolved or dispersed in water or like solvent to prepare a thermoplastic resin composition or curable resin composition. Liquid polymerizable monomers and/or the like can be used as a solvent.

The photocurable resin composition of the present invention or a known thermoplastic or curable resin composition can be applied on an optical waveguide substrate by roller coating, roll coating, spin coating, knife edge coating, curtain roll coating, spray coating, electrostatic coating, dip coating, silk printing or like method, and dried to form the lower cladding layer (I). The resulting coating film can be cured or dried as required, by active energy ray irradiation, heating or like method.

Alternatively, a known thermoplastic or curable resin composition may be applied on a base film by roller coating, roll coating, spin coating, knife edge coating, curtain roll coating, spray coating, electrostatic coating, dip coating, silk printing, and dried to form a dry film layer on the base film. After peeling off the base film, the dry film can be bonded to an optical waveguide substrate by applying heat and/or pressure to thereby form the lower cladding layer (I). Further alternatively, a laminate comprising a dry film layer formed on a base film may be bonded to an optical waveguide substrate by applying heat and/or pressure, followed by peeling off the base film, to thereby form the lower cladding layer (I) on a surface of the substrate. The lower cladding layer (I) can also be formed using the photocurable dry film of the present invention.

The dry film layer bonded to an optical waveguide substrate surface may be cured or dried by active energy ray irradiation, heating or the like as required, to obtain the lower cladding layer (I).

From the viewpoint of environmental protection, safety, workability, etc., it is especially preferable to form the lower cladding layer (I) using a dry film.

Core (II)

The core (II) is formed on part of the surface of the lower cladding layer (I).

The core (II) can be formed using the optical waveguide-forming photocurable resin composition or dry film of the present invention, or using a known resin composition or dry film.

Known resin composition and dry films are described below.

Examples of known resin compositions include thermoplastic resin compositions, thermosetting resin compositions, negative-type active energy ray-sensitive resin compositions, positive-type active energy ray-sensitive resin compositions, etc. It is preferable to use a negative-type active energy ray-sensitive resin composition or positive-type active energy ray-sensitive resin composition. Examples of thermoplastic resin compositions include those mentioned above for use in the lower cladding layer.

It is preferable to use a negative-type or positive-type active energy ray-sensitive resin composition as such or as a dry film.

Negative-type active energy ray-sensitive resin compositions are such compositions that when films formed therefrom are cured by irradiation with energy rays such as ultraviolet rays, visible rays, heat rays, etc., the films become insoluble in developers and thereby form cores. Known such resin compositions can be used without limitation. Specifically, it is preferable to use, for example, an aqueous or organic solvent-based composition comprising as an essential component a compound having at least two ring-opening polymerizable functional groups per molecule, and optionally an active energy ray polymerization initiator; or an aqueous or organic solvent-based composition comprising a polymerizable unsaturated compound, unsaturated resin, and optionally an active energy ray polymerization initiator.

Known positive-type active energy ray-sensitive resin compositions can be used without limitation, as long as films formed therefrom are decomposed when irradiated with energy rays such as ultraviolet rays, visible rays, heat rays, etc., so as to change the solubility of the irradiated portions of the films in developers and thereby form cores.

Examples of positive-type active energy ray-sensitive resin compositions include compositions each containing, as a main component, a resin in which a quinonediazidesulfonic acid is linked, via a sulfonic ester bond, to a base resin such as an acrylic resin having ion-forming groups. Such compositions are disclosed in Japanese Unexamined Patent Publication Nos. 1986-206293, 1995-133449, etc. These compositions are naphthoquinonediazide photosensitive compositions that make use of a reaction in which a quinonediazide group is photolyzed by light irradiation to form an indenecarboxylic acid via a ketene.

Examples of positive-type active energy ray-sensitive resin compositions also include those that make use of such a mechanism that when crosslinked films insoluble in alkaline and acid developers are formed by heating the compositions and then irradiated with light, the crosslinked structure is cleaved by the action of photoacid generators that generate acid groups upon irradiation with light, so that the irradiated portions become soluble in alkaline and acid developers. Such compositions are disclosed in Japanese Unexamined Patent Publication Nos. 1994-295064, 1994-308733, 1994-313134, 1994-313135, 1994-313136, 1995-146552, etc.

Photoacid generators are compounds that generate acid upon exposure to light, and decompose resins by the catalytic action of the generated acid. Known photoacid generators are usable.

Known positive-type heat-sensitive resin compositions are usable, including, for example, compositions containing a heat sensitive resin, ether bond-containing olefinically unsaturated compound and thermoacid generator. Such a composition is disclosed in Japanese Unexamined Patent Publication No. 2000-187326.

To form the core (II) using the resin composition of the present invention or a known resin composition, the resin composition for forming the core is applied on the surface of the lower cladding layer (I) by roller coating, roll coating, spin coating, knife edge coating, curtain roll coating, spray coating, electrostatic coating, dip coating, silk printing or like method, and dried to form a film of the composition. The film is then irradiated with active energy rays to form a core pattern, and then developed to remove the unirradiated portion when the resin composition of the present invention or a negative-type active energy ray-sensitive resin composition is used, or remove the irradiated portion when a positive-type active energy ray-sensitive resin composition is used, thereby forming the core (II).

From the viewpoint of environmental protection, safety, workability, etc., a known resin composition is preferably used in the form of a dry film. In this case, the composition is applied on a base film by roller coating, roll coating, spin coating, knife edge coating, curtain roll coating, spray coating, electrostatic coating, dip coating, silk printing or like method, and dried to form a dry film layer on the base film. The base film is then peeled off, and the dry film is bonded onto the lower cladding layer (I) by applying heat and/or pressure, thereby forming a film of the composition. Alternatively, a laminate comprising a dry film layer formed on a surface of a base film may be bonded onto the lower cladding layer (I) by applying heat and/or pressure, followed by peeling off the base film, to thereby form a film of the composition on the lower cladding layer (I). A film of the resin composition of the present invention can be formed by following the above procedure and using the photocurable dry film of the present invention.

The surface of the film of the composition is irradiated with active energy rays to form a core pattern, and then the film is developed to remove the unirradiated portion when the resin composition of the present invention or a negative-type active energy ray-sensitive resin composition is used, or remove the irradiated portion when a positive-type active energy ray-sensitive resin composition is used, thereby forming the core (II).

When a thermosetting resin composition is used to form the core (II), the composition is applied to the surface of the lower cladding layer (I) by roller coating, roll coating, spin coating, knife edge coating, curtain roll coating, spray coating, electrostatic coating, dip coating, silk printing or like method, and dried to form a film of the composition. The applied thermosetting composition is, for example, shaped by molding to form a patterned core (II).

Upper Cladding Layer (III)

The upper cladding layer (III) can be formed using the optical waveguide-forming photocurable resin composition or dry film of the present invention. It is also possible to form the upper cladding layer (III) using a known composition or dry film containing, for example, a thermoplastic resin, curable resin or like resin.

Known resin compositions and dry films as mentioned above for use in the lower cladding layer (I) can be used in the upper cladding layer (III).

The upper cladding layer (III) can be formed in the same manner as for forming the lower cladding layer (I).

Specifically, the upper cladding layer (III) can be formed by applying the photocurable resin composition of the present invention or a known thermoplastic or curable resin composition on the surfaces of the lower cladding layer (I) and core (II) by roller coating, roll coating, spin coating, knife edge coating, curtain roll coating, spray coating, electrostatic coating, dip coating, silk printing or like method, followed by drying. The resulting coating film can be cured or dried by active energy ray irradiation, heating or like method, as required.

Alternatively, a known thermoplastic resin composition or curable resin composition may be applied on a base film by roller coating, roll coating, spin coating, knife edge coating, curtain roll coating, spray coating, electrostatic coating, dip coating, silk printing or like method, and dried to form a dry film layer on a surface of the base film. After peeling off the base film, the dry film can be bonded to the surfaces of the lower cladding layer (I) and core (II) by applying heat and/or pressure, thereby forming the upper cladding layer (III). Further alternatively, a laminate comprising a dry film layer formed on a surface of a base film may be bonded to the surfaces of the lower cladding layer (I) and core (II) by applying heat and/or pressure, followed by peeling off the base film, to form the upper cladding layer (III). The upper cladding layer (III) can be formed by following the above procedure and using the photocurable dry film of the present invention.

Use of a dry film to form the upper cladding layer (III) improves the environmental friendliness, safety, workability, etc.

When the upper cladding layer (III) is formed using a thermosetting resin composition or active energy ray-curable resin, the upper cladding layer as a dry film before being bonded to the surfaces of the lower cladding layer (I) and core (II) preferably has a softening temperature within the range of about 0° C. to about 300° C., and more preferably within the range of about 10° C. to about 250° C.

When the dry film has a softening temperature lower than the above, the dry film is softened and becomes sticky when heated for bonding to the substrate, making bonding operation extremely difficult and/or forming bubbles after bonding. When the dry film has a softening temperature higher than the above, bonding the dry film is difficult.

The dry film for forming the upper cladding layer (III) preferably has a softening temperature lower than that of the core (II), preferably by 10° C. or more. The softening temperature of the core (II) depends on the type of resin composition forming the core.

In view of the durability, heat resistance, processability, optical transmission properties, etc., the resin composition forming the upper cladding layer (III) is preferably cured by active energy ray irradiation, heating or like method.

To form the upper cladding layer (III) using a dry film, the dry film formed on a base film is placed so that the surface of the dry film comes into contact with the surfaces of the core (II) and lower cladding layer (I); suitable heat and pressure are applied to the surface of the base film at a temperature at least 10° C. higher than the softening temperature of the dry film, by a pressure-bonding method such as atmospheric-pressure hot roll bonding, vacuum hot roll bonding, vacuum hot press bonding, etc.; and if necessary, the base film is peeled off from the dry film to transfer the dry film onto the core (II) and lower cladding layer (I); thereby forming an upper cladding layer on the surfaces of the core (II) and lower cladding layer (I).

Active energy rays that can be used in the production of the optical waveguide include visible rays, ultraviolet rays, infrared rays, x-rays, α-rays, β-rays, γ-rays, etc. It is preferable to use, for example, a high-pressure mercury lamp, low-pressure mercury lamp, metal halide lamp, excimer lamp or the like, as an irradiation device. There is no limitation on the exposure intensity. It is preferable to perform exposure by irradiation with rays having a wavelength of 200 to 440 nm and an illuminance of 1 to 500 mW/cm² at an exposure intensity of 10 to 5,000 mJ/cm².

In the optical waveguide of the present invention and production process therefor, an active energy ray-curable and thermosetting composition can be used as a curable resin composition or a dry film thereof. Such a composition can be obtained by, for example, mixing an active energy ray-curable resin composition and thermosetting resin composition. When using an active energy ray-curable and thermosetting resin composition, a firmer lower cladding layer can be obtained by, for example, further curing the photocured lower cladding layer (I) by heating. A firmer core (II) and upper cladding layer (III) can be obtained similarly.

In the formation of the lower cladding layer (I), core (II) and upper cladding layer (III), heat curing may be performed after formation of each layer; or after formation of the lower cladding layer (I) and core (II) and after formation of the upper cladding layer (III); or after formation of the lower cladding layer (I), core (II) and upper cladding layer (III).

### EFFECTS OF THE INVENTION

The present invention exhibits the following remarkable effects.

(1) The carboxy-containing unsaturated polyurethane resin (A) contained in the optical waveguide-forming photocurable resin composition of the present invention can be produced in a simple and easy manner, by reacting the polyisocyanate compound (a), carboxy-containing polyol (b), hydroxy-containing unsaturated compound (c), and optionally polyol (d). Further, the high reactivity between isocyanate groups and hydroxy groups ensures the introduction of unsaturated groups and carboxy groups into the resin (A).

(2) The optical waveguide-forming photocurable resin composition of the present invention is capable of forming a coating film having excellent processability, excellent mechanical properties, etc., and thus is highly suitable for use as a dry film.

(3) The use of an aromatic polyisocyanate compound in the production of the carboxy-containing unsaturated polyurethane resin (A) makes the refractive index of the composition of the present invention high. Thus, the photocurable resin composition and dry film of the present invention are advantageous in that they can form cores with high refractive indices.

(4) Since at least one of the lower cladding layer (I), core (II) and upper cladding layer (III) in the optical waveguide of the present invention is formed using the photocurable resin composition or photocurable dry film of the present invention, the optical waveguide of the present invention has high durability, high heat resistance, excellent processability, excellent optical transmission properties, etc.

(5) Accordingly, the optical waveguide of the present invention can be advantageously used for connecting optical fibers to optical devices such as optical integrated circuits, optical modulators, optical switches, optical connectors, optical branching and coupling devices, thin film devices, etc.

### BEST MODE FOR CARRYING OUT THE INVENTION

The following Examples and Comparative Examples are provided to illustrate the present invention in further detail.

The relative refractive index difference, transmission loss, core gap, core shape precision, core-covering properties and workability of the optical waveguides obtained in Examples 7 to 9 and Comparative Example 5 were evaluated by the following methods.

Relative refractive index difference: The refractive indices of film samples obtained from the resin compositions or dry films used for forming the core and whichever of the upper cladding layer and lower cladding layer that has the higher refractive index were measured at 23° C. using a multi-wavelength Abbe refractometer “DR-M4” (product of Atago Co., Ltd.) with an interference filter having a wavelength of 850 nm. Using the refractive indices obtained, the relative refractive index difference (%) was calculated according to equation (1) shown above.

Transmission loss: Light having a wavelength of 850 nm was input to one end of the optical waveguide, and the amount of light output from the other end was measured to determine the transmission loss per unit length using the cut-back method. A indicates good transmission properties with a loss of not more than 0.4 dB/cm; and B, poor transmission properties with a loss of more than 0.4 dB/cm.

Core gap: A indicates that there was no gap between the projecting core and the upper cladding layer; B indicates that there was a gap, and, when an organic solvent-based composition was used, shows that popping and bubbling were generated.

Core shape precision: A indicates that the core was not deformed by the upper cladding layer; and B indicates that the core was deformed by the upper cladding layer.

Core-covering properties: A indicates that the thickness of the upper cladding layer at the portion over the projecting core was sufficient; B indicates that the thickness of the upper cladding layer at the portion over the projecting core was slightly small; and C indicates that the thickness of the upper cladding layer at the portion over the projecting core was small.

Workability: A indicates that the entire process for forming the optical waveguide was simple and easy; B indicates that the entire process was slightly complicated; and C indicates that the entire process was complicated and difficult.

### Example 1 Production of Photocurable Resin Composition (1)

One hundred grams of carboxy-containing unsaturated polyurethane resin obtained by adding 2 mol of trimethylolpropane diacrylate to a reaction product of 1 mol of dimethylolbutanoic acid with 2 mol of tolylene diisocyanate, 3 g of polymerization initiator (aminoalkylphenone radical photopolymerization initiator, tradename “Irgacure 907”, product of Ciba Speciality Chemicals) and 400 g of ethyl acetate were mixed to obtain photocurable resin composition (1) of the present invention.

### Example 2 Production of Photocurable Resin Composition (2)

One hundred grams of carboxy-containing unsaturated polyurethane resin obtained by adding 2 mol of trimethylolpropane diacrylate to a reaction product of 1 mol of dimethylolbutanoic acid with 2 mol of hexamethylene diisocyanate, 3 g of polymerization initiator (aminoalkylphenone radical photopolymerization initiator, tradename “Irgacure 907”, product of Ciba Speciality Chemicals) and 400 g of ethyl acetate were mixed to obtain photocurable resin composition (2) of the present invention.

### Comparative Example 1 Production of Photocurable Resin Composition (3)

Forty grams of methyl methacrylate, 20 g of styrene, 20 g of butyl acrylate and 20 g of acrylic acid were subjected to a radical polymerization reaction at 110° C. to obtain an acrylic resin solution. Twenty four grams of glycidyl methacrylate, 0.12 g of hydroquinone and 0.6 g of tetraethylammonium bromide were then added to the solution, and a reaction was carried out at 110° C. for 5 hours while introducing air, to thereby obtain a methacryloyl-containing acrylic resin. One hundred grams (solids) of the resin, 3 g of polymerization initiator (aminoalkylphenone radical photopolymerization initiator, tradename “Irgacure 907”, product of Ciba Speciality Chemicals), and 400 g of ethyl acetate were mixed to obtain comparative photocurable resin composition (3).

### Comparative Example 2 Production of Photocurable Resin Composition (4)

Forty grams of methyl methacrylate, 40 g of butyl acrylate and 20 g of acrylic acid were subjected to a radical reaction at 110° C. to obtain an acrylic resin solution. Twenty four grams of glycidyl methacrylate, 0.12 g of hydroquinone and 0.6 g of tetraethylammonium bromide were added to the solution, and a reaction was carried out at 110° C. for 5 hours while introducing air, to thereby obtain a methacryloyl-containing acrylic resin. Subsequently, 100 g (solids) of the resin, 3 g of polymerization initiator (aminoalkylphenone polymerization initiator, tradename “Irgacure 907”, product of Ciba Speciality Chemicals) and 400 g of ethyl acetate were mixed to obtain comparative photocurable resin composition (4).

### Example 3 Preparation of Photocurable Dry Film (i)

Photocurable resin composition (1) was applied on a polyethylene terephthalate base film (film thickness: 25 μm) with a knife edge coater, and dried at 80° C. for 30 minutes to obtain photocurable dry film (i) of the present invention.

### Example 4 Preparation of Photocurable Dry Film (ii)

Photocurable resin composition (2) was applied on a polyethylene terephthalate base film (film thickness: 25 μm) with a knife edge coater, and dried at 80° C. for 30 minutes to obtain photocurable dry film (ii).

### Comparative Example 3 Preparation of Photocurable Dry Film (iii)

Photocurable resin composition (3) was applied on a polyethylene terephthalate base film (film thickness: 25 μm) with a knife edge coater, and dried at 80° C. for 30 minutes to obtain comparative photocurable dry film (iii).

### Comparative Example 4 Preparation of Photocurable Dry Film (iv)

Photocurable resin composition (4) was applied on a polyethylene terephthalate base film (film thickness: 25 μm) with a knife edge coater, and dried at 80° C. for 30 minutes to obtain comparative photocurable dry film (iv).

### Example 5 Preparation of Photocurable Resin Composition (5) and Dry Film (v)

One hundred grams of carboxy-containing unsaturated polyurethane resin obtained by adding 2 mol of trimethylolpropane diacrylate to a reaction product of 1 mol of dimethylolbutanoic acid with 3 mol of tolylene diisocyanate, 3 g of polymerization initiator (aminoalkylphenone radical photopolymerization initiator, tradename “Irgacure 907”, product of Ciba Speciality Chemicals) and 400 g of ethyl acetate were mixed to obtain photocurable resin composition (5) of the present invention.

The composition was applied on a polyethylene terephthalate base film (film thickness: 25 μm) with a knife edge coater, and dried at 80° C. for 30 minutes to obtain photocurable dry film (v) of the present invention.

### Example 6 Preparation of Photocurable-Resin Composition (6) and Dry Film (vi)

One hundred grams of carboxy-containing unsaturated polyurethane resin obtained by adding 2 mol of trimethylolpropane diacrylate to a reaction product of 1 mol of dimethylolbutanoic acid, 3 mol of hexamethylene diisocyanate and 1 mol of dipropylene glycol, 3 g of polymerization initiator (aminoalkylphenone radical photopolymerization initiator, tradename “Irgacure 907”, product of Ciba Speciality Chemicals) and 400 g of ethyl acetate were mixed to obtain photocurable resin composition (6) according to the present invention.

The composition was applied on a polyethylene terephthalate base film (film thickness: 25 μm) with a knife edge coater, and dried at 80° C. for 30 minutes to obtain photocurable dry film (vi) of the present invention.

### Example 7 Production of Optical Waveguide

(1) Formation of Lower Cladding Layer

Photocurable resin composition (2) was applied on a surface of a silicon substrate by spin coating, and irradiated for 100 seconds with ultraviolet rays having a wavelength of 365 nm and an illuminance of 10 mW/cm² to form a lower cladding layer with a thickness of 40 μm.

(2) Formation of Core

Photocurable resin composition (1) was applied on the lower cladding layer by spin coating, and dried at 80° C. for 30 minutes. Subsequently, the resulting coating film was partially cured by irradiation for 100 seconds with ultraviolet rays having a wavelength of 365 nm and an illuminance of 10 mW/cm², via a photomask having a pattern consisting of 30 μm-wide lines. The substrate with the ultraviolet ray-irradiated coating film was immersed in a developer made of an aqueous 1.8 wt. % tetramethylammonium hydroxide (TMAH) solution to dissolve the unexposed portion of the coating film, followed by drying. A core having a pattern consisting of 30 μm-wide lines was thus formed.

(3) Formation of Upper Cladding Layer

Photocurable resin composition (2) was applied on the surfaces of the core and lower cladding layer by spin coating, and irradiated for 100 seconds with ultraviolet rays having a wavelength of 365 nm and an illuminance of 10 mW/cm² to form an upper cladding layer with a thickness of 40 μm.

The optical waveguide thus obtained was evaluated with respected to relative refractive index difference, transmission loss, core gap, core shape precision, core-covering properties and workability. As a result, the relative refractive index difference was at least 0.1%; and the transmission loss was rated as A, core gap as A, core shape precision as A, core-covering properties as A, and workability as A.

### Example 8 Production of Optical Waveguide

(1) Formation of Lower Cladding Layer

Photocurable dry film (ii) was transferred onto a surface of a silicon substrate by atmospheric-pressure hot roll bonding (temperature: 100° C.), and the base film was peeled off. The dry film was then cured by irradiation for 100 seconds with ultraviolet rays having a wavelength of 365 nm and an illuminance of 10 mW/cm² to form a lower cladding layer with a thickness of 40 μm.

(2) Formation of Core

Subsequently, photocurable dry film (i) was transferred onto the lower cladding layer by atmospheric-pressure hot roll bonding (temperature: 100° C.), and the base film was peeled off. The resulting coating film was partially cured by irradiation for 100 seconds with ultraviolet rays having a wavelength of 365 nm and an illuminance of 10 mW/cm², via a photomask having a pattern consisting of 30 μm-wide lines. The substrate with the ultraviolet ray-irradiated coating film was immersed in a developer made of an aqueous 1.8 wt. % tetramethylammonium hydroxide (TMAH) solution to dissolve the unexposed portion of the coating film, followed by drying. A core having a pattern consisting of 30 μm-wide lines was thus formed.

(3) Formation of Upper Cladding Layer

Photocurable dry film (ii) was transferred onto the surfaces of the lower cladding layer and core by atmospheric-pressure hot roll bonding (temperature: 100° C.), and the base film was peeled off. The dry film was then cured by irradiation for 100 seconds with ultraviolet rays having a wavelength of 365 nm and an illuminance of 10 mW/cm² to form an upper cladding layer with a thickness of 40 μm.

The optical waveguide thus obtained was evaluated with respect to the relative refractive index difference, transmission loss, core gap, core shape precision, core-covering properties and workability. As a result, the relative refractive index difference was at least 0.1%; and the transmission loss was rated as A, core gap as A, core shape precision as A, core-covering properties as A and workability as A.

### Example 9 Production of Optical Waveguide

An optical waveguide was produced in the same manner as in Example 8 except that the core was formed using photocurable dry film (v) in place of photocurable dry film (i), and that the upper and lower cladding layers were formed using photocurable dry film (vi) in place of photocurable dry film (ii).

The optical waveguide thus obtained were evaluated with respect to the relative refractive index difference, transmission loss, core gap, core shape precision, core-covering properties and workability. As a result, the relative refractive index difference was at least 0.1%; and the transmission loss was rated as A, core gap as A, core shape precision as A, core-covering properties as A and workability as A.

### Comparative Example 5 Production of Optical Waveguide

(1) Formation of Lower Cladding Layer

Photocurable resin composition (4) was applied on a surface of a silicon substrate by spin coating, and irradiated for 100 seconds with ultraviolet rays having a wavelength of 365 nm and an illuminance of 10 mW/cm² to form a lower cladding layer with a thickness of 40 μm.

(2) Formation of Core

Subsequently, photocurable resin composition (3) was applied on the lower cladding layer by spin coating, dried at 80° C. for 30 minutes. The resulting coating film was partially cured by irradiation for 100 seconds with ultraviolet rays having a wavelength of 365 nm and an illuminance of 10 mW/cm², via a photomask having a pattern consisting of 30 μm-wide lines. The substrate with the ultraviolet ray-irradiated coating film was immersed in a developer made of an aqueous 1.8 wt. % tetramethylammonium hydroxide (TMAH) solution to dissolve the unexposed portion of the coating film, followed by drying. A core having a pattern consisting of 30 μm-wide lines was thus formed.

(3) Formation of Upper Cladding Layer

Photocurable resin composition (4) was applied on the surfaces of the lower cladding layer and core by spin coating, and irradiated for 100 seconds with ultraviolet rays having a wavelength of 365 nm and an illuminance of 10 mW/cm² to form an upper cladding layer with a thickness of 40 μm.

The optical waveguide thus obtained was evaluated with respect to the relative refractive index difference, transmission loss, core gap, core shape precision, core-covering properties and workability. As a result, the relative refractive index difference was at least 0.1%; and the transmission loss was rated as A, core gap as A, core shape precision as B, core-covering properties as C, and workability as B.

1. A photocurable resin composition for forming an optical waveguide, the composition comprising:
(A) a carboxy-containing unsaturated polyurethane resin obtained by reacting a polyisocyanate compound (a), a carboxy-containing polyol (b) and a hydroxy-containing unsaturated compound (c); and
(B) a solvent.

2. The photocurable resin composition according to claim 1, wherein the polyisocyanate compound (a) is an aromatic diisocyanate.

3. The photocurable resin composition according to claim 1, wherein the hydroxy-containing unsaturated compound (c) is an unsaturated compound (c-1) having one hydroxy group and one unsaturated group per molecule.

4. The photocurable resin composition according to claim 1, wherein the hydroxy-containing unsaturated compound (c) is an unsaturated compound (c-2) having one hydroxy group and at least two unsaturated groups per molecule.

5. The photocurable resin composition according to claim 1, wherein the hydroxy-containing unsaturated compound (c) is an unsaturated compound (c-3) having at least two hydroxy groups and one unsaturated group per molecule.

6. The photocurable resin composition according to claim 1, wherein the hydroxy-containing unsaturated compound (c) is an unsaturated compound (c-4) having at least two hydroxy groups and at least two unsaturated groups per molecule.

7. The photocurable resin composition according to claim 1, wherein the carboxy-containing unsaturated polyurethane resin (A) is a resin obtained by reacting a polyisocyanate compound (a), a carboxy-containing polyol (b), a hydroxy-containing unsaturated compound (c), and a polyol (d) other than the polyol (b).

8. The photocurable resin composition according to claim 7, wherein the polyol (d) is an aromatic polyol.

9. The photocurable resin composition according to claim 1, further comprising a radical photopolymerization initiator.

10. A photocurable dry film for forming an optical waveguide, which is formed using the photocurable resin composition according to claim 1.

11. The photocurable dry film according to claim 10, which has a softening temperature within a range of 0° C. to 300° C.

12. An optical waveguide comprising a lower cladding layer (I), a core (II) and an upper cladding layer (III), wherein at least one of (I), (II) and (III) is formed using the photocurable resin composition according to claim 1.

13. An optical waveguide comprising a lower cladding layer (I), a core (II) and an upper cladding layer (III), wherein at least one of (I), (II) and (III) is formed using the photocurable dry film according to claim 10.
